(19) United States
(12) Patent Application Publication
(10) Pub. No.: US 2013/0026232 A1
(43) Pub. Date: Jan. 31, 2013

(54) METHODS AND SYSTEMS FOR PREVENTING CARD PAYMENT FRAUD AND RECEIVING PAYMENTS USING CODES AND MOBILE DEVICES

(71) Applicants: Tiger T G Zhou, Tiburon, CA (US); Dylan T X Zhou, San Gabriel, CA (US); Andrew H B Zhou, Tiburon, CA (US)

(72) Inventors: Tiger T G Zhou, Tiburon, CA (US); Dylan T X Zhou, San Gabriel, CA (US); Andrew H B Zhou, Tiburon, CA (US)

(21) Appl. No.: 13/646,706

(22) Filed: Oct. 7, 2012

Related U.S. Application Data
(63) Continuation-in-part of application No. 13/185,491, filed on Jul. 18, 2011.

(51) Int. Cl. G06K 9/20

(52) U.S. Cl. 235/380

(57) ABSTRACT

Provided are methods and systems for preventing card payment fraud and receiving payments using codes and mobile devices. To pay for a product, a new code payment card without visible digits may be created. A code associated with the code payment card may encode customer payment information and may be scanned by a merchant to receive payment for products. Upon scanning the code, it may be sent to a server. The server may then decode the code for retrieving customer payment information. Based on the customer payment information retrieved and product information stored on the server, purchase transaction may be processes. Based on the processing, a merchant may receive payment for products. The payment may be received from a customer account.

### CROSS-REFERENCE TO RELATED APPLICATIONS

This application is a continuation-in-part of U.S. patent application Ser. No. 13/185,491, entitled “FACILITATING MOBILE DEVICE PAYMENTS USING PRODUCT CODE SCANNING,” filed on Jul. 18, 2011, which is incorporated herein by reference in its entirety.

### FIELD

This application relates generally to mobile device payments and card payments in various retail environments and, more specifically, to methods and systems for preventing card payment fraud and receiving payments using codes and mobile devices.

### BACKGROUND

When customers present a payment to a merchant, the merchant typically makes a request for authorization before accepting the payment. Personal information, such as an account number, address, or telephone number, is often enough to initiate a payment. A serious weakness of this system is that criminals who obtain the correct personal information can impersonate an honest consumer and commit payments fraud. Payments fraud is costly to all payment participants and has direct and indirect costs that affect all members of society. The direct costs of payments fraud are spread across banks, merchants, consumers, and others, while the indirect costs, such as failure to obtain the complete benefits of Internet retailing and electronic payments, affect the entire economy.

The most common type of payment fraud occurs when a payment card or checkbook is lost or stolen and a criminal uses the card or forges a signature on a check. It can also occur using only the information on a credit card or check for Internet purchases or by creating counterfeit checks or payment cards. A second type of identity theft, called new account fraud, occurs when a criminal obtains personal information on an individual and impersonates the individual to create a new payment account, such as a checking or a credit card account.

Taking into account the aforesaid, creating a new code payment card with a code associated with customer financial information and receiving payments using codes would assure more efficient and secure payment process.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for preventing card payment fraud and receiving payments using codes and mobile devices. In general, these methods and systems are designed to assure a secure payment process and prevent payment fraud.

According to the methods and systems disclosed herein, to receive payment for products, a merchant may scan a code associated with a new code payment card, which may contain no visible digits thereon. The code may encode customer payment information, which may include credit card information, debit card information, bank checking account information, or digital money. The code may also include any linier or two-dimensional code. Upon scanning the code by the merchant, it may be decoded by a server where product information may also be stored. Based on the product information and customer payment information, purchase transaction may be processed and a payment may be received from a customer account. Additionally, to secure payment process, the code encoding customer payment information may be sent to the merchant via a user interface of a mobile device.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating overall sample environment within which methods and systems for preventing card payment fraud and receiving payments using codes and mobile devices are implemented, in accordance with certain embodiments.

FIG. 2 is a flow chart illustrating a method for receiving payments using a code payment card, in accordance with certain embodiments.

FIG. 3 illustrates an example of a mobile device, in accordance with certain embodiments.

FIG. 4 illustrates a computer system within which a set of instructions for causing the machine to perform any one or more of the methodologies discussed herein is executed, in accordance with certain embodiments.

### DETAILED DESCRIPTION

The following detailed description includes references to the accompanying drawings, which form a part of the detailed description. The drawings show illustrations in accordance with example embodiments. However, one having ordinary skills in the art would understand that methods and systems described herein may not be limited to these examples and, therefore, are not to be taken in a limiting sense.

Ever-growing card payment fraud inflicts serious losses not only on banks but also on card payment holders.

Systems and methods described herein may allow preventing card payment frauds and receiving payments using codes and mobile devices. Recent proliferation of mobile devices (e.g., cell phones/smart phones and other similar devices) that are capable of scanning various codes allows implementing these methods and systems.

According to the methods and systems described herein, a new code payment card may be created. The new code payment card may have any linier or two dimensional code applied thereon. As opposed to modern credit or debit cards, the new code payment card may have no visible digits. The code may include credit card information, debit card information, or bank checking account information. A merchant may scan the code and receive a payment for products.

In certain embodiments, to prevent payment fraud, a customer may send a code encoding his payment information to the merchant. The code may be sent via a user interface of a mobile device.

In certain embodiments, the code may be sent using online messages, text or emails.

In certain embodiments, the merchant may enter a code on a web page of an online store, on products in a retail store, or on any kind of advertising medium including TV screens, indoor or outdoor boards, magazines, newspapers, direct mailing materials. The code may encode information associated with the merchant.

In certain embodiments, the code may be displayed on plastic cards, paper cards, wallets, key chain, watches, human body, or wearing clothes.

In certain embodiments, upon providing data on a credit or debit card, or a bank checking account via the user interface of the mobile device, the customer may receive a unique code encoding his payment information. To pay for products, the unique code may be scanned by a payment receiver mobile device.

One having ordinary skills in the art would understand that the term “scanning” may involve capturing an image of the barcode using a simple imaging device installed on a mobile device, such as a digital camera.

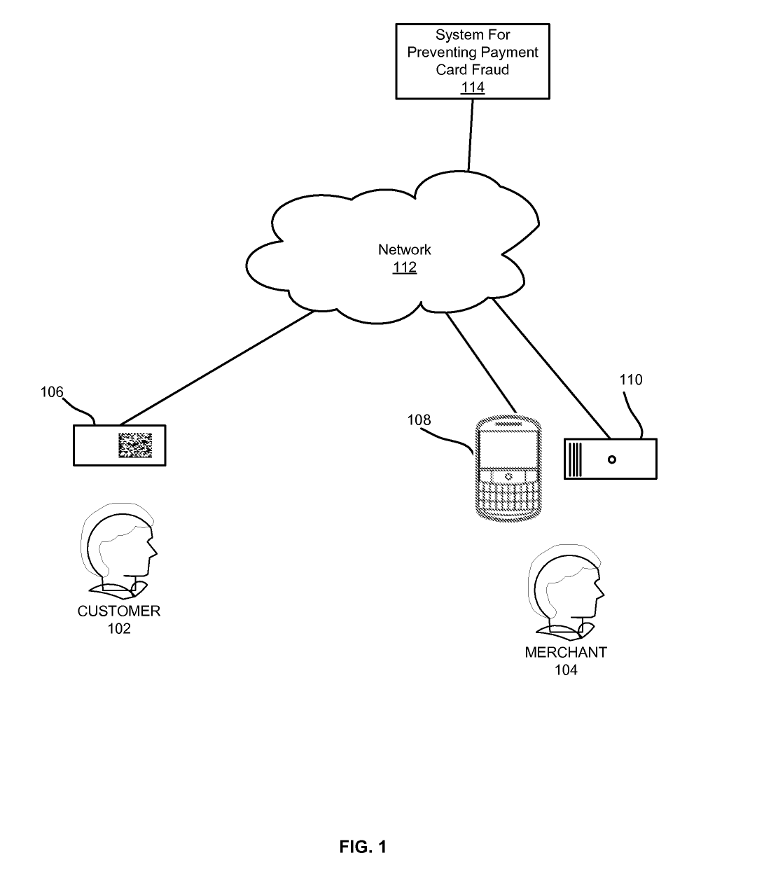

The methods described herein may be performed by any mobile devices with wireless communication capabilities. In addition to being capable of transmitting voice-based signals, many modern cell phones also have internet connectivity using cellular networks (e.g., 3G, 4G) as well as Wi-Fi and other types of networks. Some additional examples of such networks are described below with reference to FIG. 1.

Referring now to figures, FIG. 1 is a block diagram illustrating overall sample environment within which methods and systems for facilitating mobile device payments are implemented, in accordance with certain embodiments. As shown in FIG. 1, a customer 102 may provide his code payment card 106 to pay for products. To receive payment, a merchant 104 may scan a code associated with the code payment card 106 by a mobile device 108 or by a scanner 110 in a retail store.

In certain embodiments, the code may be scanned by a second mobile device, an online server, or a payment receiving service.

The mobile device 108 may include a cellular phone, a Personal Digital Assistant (PDA), a personal computer (e.g., a tablet or a laptop), a barcode scanner, and an RFID scanner. In general, any device capable of wirelessly communicating (e.g., via Wi-Fi network, 3G or 4G cellular network, or any other types of wireless communication networks) may be used.

Upon scanning the code on the code payment card 106, a server of a system for preventing payment card fraud 114 may decode the code to retrieve customer payment information. The code may be transmitted to the system for preventing payment card fraud 114 via a network 112.

The network 112 may include any type of network capable of communicating data, such as, for example, a wide area network or Internet and/or one or more local area networks (LAN's). The network 112 may also include any suitable number and type of devices, e.g., routers and switches, for forwarding commands, content, and/or web object requests from each client to the online community application and responses back to the clients.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 112 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 112 may be a network of data processing nodes that are interconnected for the purpose of data communication.

The methods described herein may also be practiced in a wide variety of network environments including, for example, TCP/IP-based networks, telecommunications networks, wireless networks, etc. In addition, the methods described herein may be executed by computer program instructions stored in any type of computer-readable media.

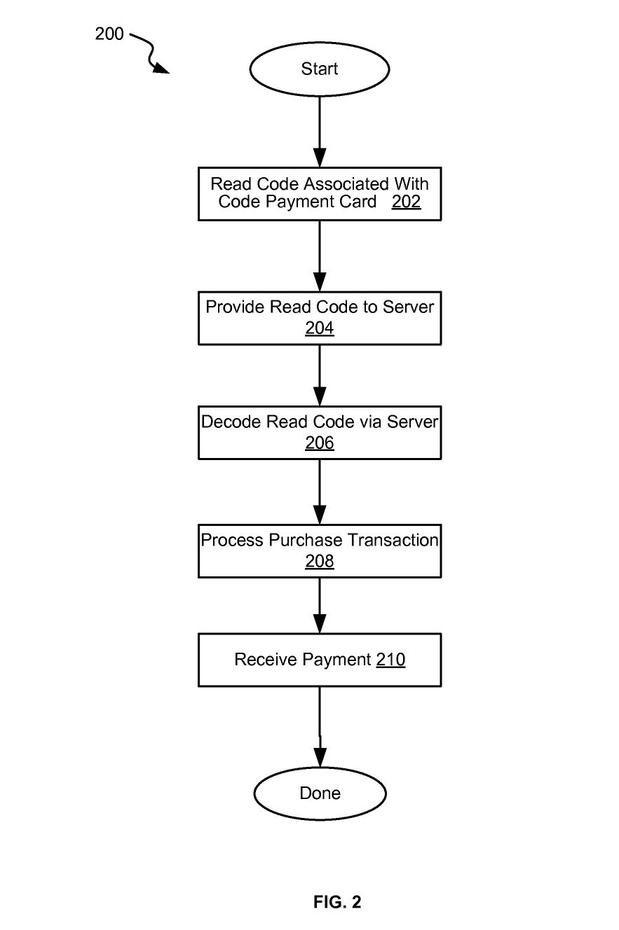

FIG. 2 is a flow chart illustrating a method for receiving payments using a code payment card, in accordance with certain embodiments. Specifically, a method 200 may commence at reading a code associated with a code payment card at operation 202. The code payment card may have no visible digits displayed thereon and may be made of plastic, paper, or light metal. The code payment card may be created in a digital virtual form. In certain embodiments, the code payment card may be also associated with existing payment cards such as Visa, MasterCard, and the like. Besides the code payment card may also use the same interface as existing payment cards. In certain embodiments, the code payment card may be based on a stand-alone system. Furthermore, the code payment card may be issued by different merchants or commercial banks. In certain embodiments, the code payment card may be issued jointly by different merchants and commercial banks. Besides, the code associated with the code payment card may encode customer payment information, which may include credit card information, debit card information, bank checking account information, or digital money. The customer payment information may not include any personal information such as card numbers, CVV code. Thus, a secure payment process may be assured, wherein the merchant may not receive any personal information and may not charge twice.

In certain embodiments, the code payment card may also encode a picture of a user face, fingerprints, or a pin code. To further enhance security, the customer may specify a time period within which the code is valid.

The code may also include any linier or two-dimensional code. Furthermore, the code may be scanned by a mobile device of a merchant or by a scanner installed in a retail store. Upon reading the code, the method 200 may further proceed with providing the reading to a server at operation 204. The server may then decode the reading for receiving the customer payment information at operation 206.

In certain embodiments, the code encoding the customer payment information may be sent to the merchant via a user interface of a mobile device.

In certain embodiments, the merchant may enter a code on a web page of an online store, on products in a retail store, or on any kind of advertising medium including TV screens, indoor or outdoor boards, magazines, newspapers, direct mailing materials. The code may encode information associated with the merchant. The information may also include payment receiving information of the merchant.

The method 200 may also include processing purchase transaction at operation 208. The processing may be based on the customer payment information and product information. The product information may be stored on the server. Upon processing the purchase transaction, the method 200 may then further proceed with receiving a payment for products. The payment may be received from a customer account.

In certain embodiments, a customer may provide his payment information via user interface of a mobile device and receive a unique code.

The unique code may be displayed on a screen of the mobile device and may include any code, such as, for example, a linear code, QR code, or any other two-dimensional code. Once the unique code has been received, the customer may set up a password for this unique code to assure a secure access to his payment account when transferring payment to the merchant. The customer may then scan a product barcode with the mobile device.

To pay for a product, the customer may show the unique code displayed on the screen of his mobile device for a payment receiver to scan the unique code with the mobile device.

In certain embodiments, the unique code may be received from a code issuer. The code issuer may include any financial institution or any mobile payment service provider, and the customer may transfer payment directly to that code issuer, since the unique code may include all financial information of the code issuer.

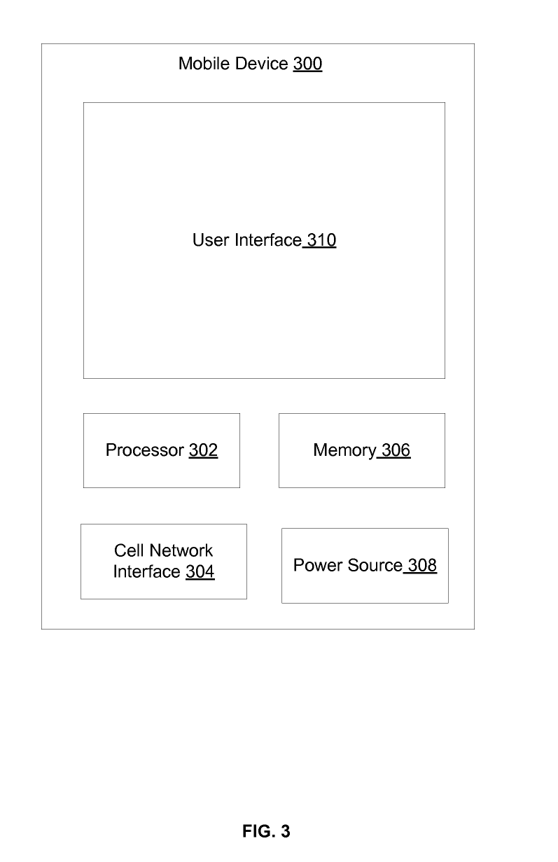

FIG. 3 illustrates an example of a mobile device, in accordance with certain embodiments. The mobile device 300 includes a processor 302, a memory 306, a user interface 310, a cellular network interface 304, and a power source 308. The processor 302 may be specifically configured to process purchase transactions based on the customer payment information and product information. The user interface 310, such as an LCD screen, is configured to display one or more codes and product information. The memory 306 may be configured to store various security features associated with the purchase transactions. Furthermore, advanced processing, communicating, scanning and displaying capabilities of the mobile devices and more frequent use of these capabilities may need substantial power outputs provided by the power source 308.

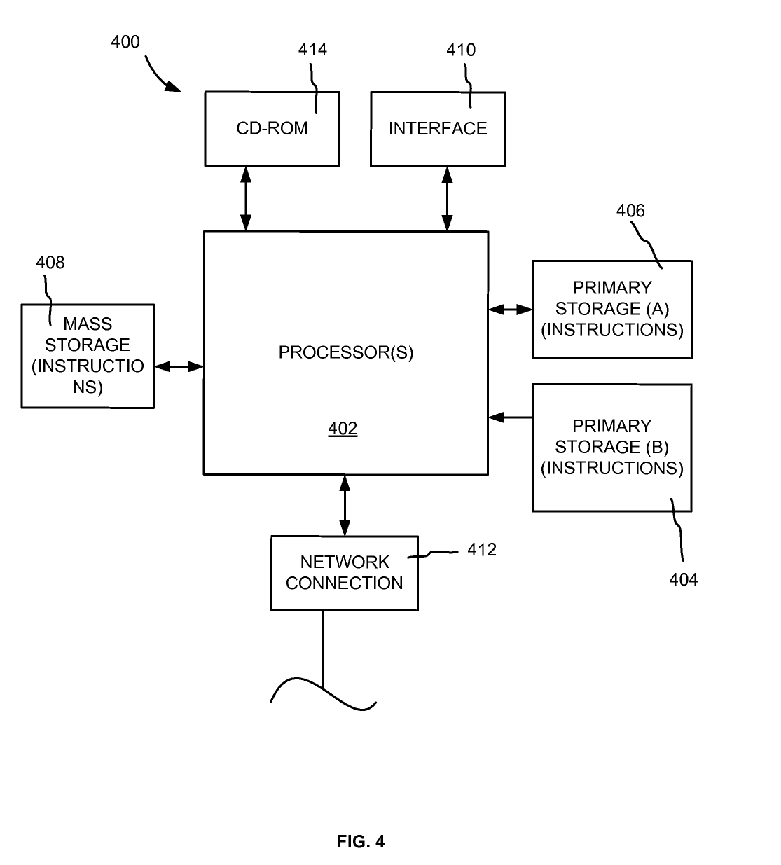

FIG. 4 illustrates a computer system within which a set of instructions for causing the machine to perform any one or more of the methodologies discussed herein is executed, in accordance with certain embodiments.

A computer system 400 includes any number of processors 402 (also referred to as central processing units, or CPUs) that are coupled to storage devices including a primary storage 406 (typically a random access memory, or RAM), a primary storage 404 (typically a read only memory, or ROM). The CPU 402 may be of various types including microcontrollers and microprocessors such as programmable devices (e.g., CPLDs and FPGAs) and unprogrammable devices such as gate array ASICs or general purpose microprocessors. The primary storage 404 may act to transfer data and instructions uni-directionally to the CPU 402 and the primary storage 406 is used typically to transfer data and instructions in a bi-directional manner. Both of these primary storage devices may include any computer-readable media. A computer-readable media may comprise instructions, which when executed by the CPU 402 may perform the operations described above with reference to FIG. 2. A mass storage device 408 is also coupled bi-directionally to the CPU 402 and provides additional data storage capacity. The mass storage device 408 may also include any computer-readable media. The mass storage device 408 may be used to store programs, data, and the like, and is typically a secondary storage medium such as a hard disk. It will be appreciated that the information retained within the mass storage device 408, may, in appropriate cases, be incorporated in standard fashion as a part of the primary storage 406 as a virtual memory. A specific mass storage device such as a CD-ROM 414 may also transmit data uni-directionally to the CPU 402.

In addition, the computer program instructions to perform any one or more of the methodologies discussed herein may be stored in any type of computer-readable media.

The CPU 402 may also be coupled to an interface 410 that connects to one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, the CPU 402 may optionally be coupled to an external device such as a database or a computer or telecommunications network using a network connection 412. Being connected via a network, the CPU 402 may receive information from the network, or may output information to the network when performing the operations described herein.

The example embodiments described herein may be implemented in an operating environment including software installed on a computer, in hardware, or in a combination of software and hardware.

Thus, although embodiments have been described with reference to specific example embodiments, it will be evident, that various modifications and changes may be made to these embodiments without departing from the broader spirit and scope of the systems and methods described herein.

What is claimed is:

1. A method for receiving payments using a code payment card, the method comprising:
reading a code associated with the code payment card of a customer, the code encoding customer payment information;
providing the reading to a server;
decoding the reading via the server for receiving the customer payment information;
based on the customer payment information and product information, processing purchase transaction, the product information being stored on the server; and
based on the processing, receiving a payment for one or more products, the payment being received from a customer account.

2. The method of claim 1, wherein the code includes any linier and two-dimensional code.

3. The method of claim 1, wherein the payment card contains no visible digits thereon.

4. The method of claim 1, wherein the customer payment information includes one or more of the following: credit card information, debit card information, bank checking account information, and digital money.

5. The method of claim 1, wherein the code is read by one or more of the following: a mobile device of a merchant, a scanner installed in a retail store, an online server, a payment receiving service, a second mobile device.

6. The method of claim 1, wherein the code is sent to a merchant using one or more of the following: a user interface of a mobile device, online messages, text, emails.

7. The method of claim 1, wherein the merchant enters a code or a QR code on one or more of the following: a logo, a trademark, a picture, a photo, a word, a web page of an online store, TV screens, indoor or outdoor boards, magazines, newspapers, direct mailing materials, products in a retail store.

8. The method of claim 7, wherein the code encodes information associated with the merchant.

9. The method of claim 1, wherein the code or QR oce is displayed on one or more of the following: a logo, a trademark, a picture, a photo, a word, plastic cards, paper cards, wallets, key chain, watches, human body, wearing clothes.

10. The method of claim 1, wherein the customer provides customer payment information via a user interface of a mobile device and, in response, receives a unique code encoding the customer payment information.

11. The method of claim 10, wherein the unique code is scannable by one or more of the following: a payment receiving device, a mobile device of a merchant.

12. The method of claim 1, wherein the code payment card is made of one or more of the following: plastic, paper, light metal.

13. The method of claim 1, wherein the code or QR code payment card is created in a digital virtual form, a logo, a trademark, a picture, a photo, and a word.

14. The method of claim 1, wherein the code payment card is associated with existing payment cards.

15. The method of claim 1, wherein the code payment card is based on a stand-alone system.

16. The method of claim 1, wherein the code payment card is issued by one or more merchants or one or more commercial banks.

17. The method of claim 1, wherein the code payment card is issued jointly by one or more commercial banks and one or more merchants.

18. The method of claim 1, wherein the code payment card uses the same interface as existing payment cards.

19. The method of claim 1, wherein the customer payment information does not include personal information.

20. The method of claim 19, wherein the personal information includes one or more of the following: card numbers, CVV code.

21. The method of claim 1, wherein the customer specifies a time period within which the code is valid.

22. The method of claim 1, wherein the code payment card encodes one or more of the following: a picture of a user face, fingerprints, and a pin code.

23. A system for making payments using code payment card, the system comprising a processor configured to:
read a code associated with the code payment card of a customer, the code encoding customer payment information;
provide the reading to a server;
decode the reading via the server for receiving the customer payment information;
based on the customer payment information and product information, process purchase transaction, the product information being stored on the server; and
based on the processing, receive a payment for one or more products, the payment being received from a customer account.

24. The system of claim 23, wherein the code includes any linier and two-dimensional code.

25. The system of claim 23, wherein the payment card contains no visible digits thereon.

26. The system of claim 23, wherein the customer payment information includes one or more of the following: credit card information, debit card information, bank checking account information, and digital money.

27. The system of claim 23, wherein the code is read by one or more of the following: a mobile device of a merchant, a scanner installed in a retail store, an online server, payment receiving service, second mobile device.

28. The system of claim 23, wherein the merchant enters a code associated with one or more of the following: a web page of an online store, a TV screen, an indoor board, an outdoor board, a magazine, a newspaper, direct mailing material, and a product in a a retail store.

29. The system of claim 28, wherein the code encodes information is associated with the merchant.

30. The system of claim 23, wherein the customer provides customer payment information via a user interface of a mobile device and, in response, receives a unique code encoding the customer payment information.

31. The system of claim 30, wherein the unique code is scannable by one or more of the following: a payment receiving device, a mobile device of a merchant.

32. A computer-readable medium comprising instructions, which when executed by one or more processors, perform the following operations:
read a code associated with the code payment card of a customer, the code encoding customer payment information;
provide the reading to a server;
decode the reading via the server for receiving the customer payment information;
based on the customer payment information and product information, process purchase transaction, the product information being stored on the server; and
based on the processing, receive a payment for one or more products, the payment being received from a customer account.
